(19) United States
(12) Patent Application Publication
(10) Pub. No.: US 2022/0076174 A1
(43) Pub. Date: Mar. 10, 2022

(54) INTEGRATED MATERIALS AND SERVICES FORECASTING PROCESS AND MODEL FOR ENERGY COMPANY

(71) Applicant: Saudi Arabian Oil Company, Dhahran (SA)

(72) Inventor: Abdulrahman AlAbdulkarim, Dhahran (SA)

(21) Appl. No.: 17/014,539

(22) Filed: Sep. 8, 2020

(51) Int. Cl. G06Q 10/04; G06Q 40/04; G06Q 10/06

(52) U.S. Cl. CPC G06Q 10/04; G06Q 10/06; G06Q 40/04

(57) ABSTRACT

Systems and methods include a computer-implemented method for determining a future cost of procurement. A first estimate of prices of contract activities of existing contracts of a company is determined. A second estimate of prices of new contracts for new facilities, projects, and plants is determined. A third estimate of the forecasted volume and types of contracts activities for other company operations, functions, and organizations is determined. A fourth estimate of the total cost of contracts and contract-related activities for the company is determined using the first, second, and third estimates. A future cost of procurement is determined based on a total forecasted cost of materials and the fourth estimate.

### BACKGROUND

The present disclosure applies to forecasting costs materials and services.

Conventional processes used by companies or other entities to forecast costs materials and services typically rely on several non-integrated processes and systems. This can be true especially for companies that provide oil, gas, refining, or chemical storage facilities. For example, an oil company may have separate drilling and upstream plans. A separate system may be used for mega projects. Yet other separate systems may be used for maintaining potential and operations plans.

### SUMMARY

The present disclosure describes techniques that can be used to develop and establish an integrated materials and services forecasting process and model, for example, for an energy company. In some implementations, a computer-implemented method includes the following. A first estimate of prices of contract activities of existing contracts of a company is determined. A second estimate of prices of new contracts for new facilities, projects, and plants is determined. A third estimate of the forecasted volume and types of contracts activities for other company operations, functions, and organizations is determined. A fourth estimate of the total cost of contracts and contract-related activities for the company is determined using the first, second, and third estimates. A future cost of procurement is determined based on a total forecasted cost of materials and the fourth estimate.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, a fully-integrated materials and services forecasting process and model can be provided for an energy or petrochemical company. Second, the use of a model can improve the accuracy and availability of data forecasting related to materials and future requirements of contracts. Third, a real-time dashboard or snapshot can provide an up-to-date estimate of the future costs of procurement of the company, such as based on a sum of the estimated cost of materials and the estimated total cost of future contracts and corresponding activities. The term real-time can correspond to events that occur, for example, within a specified period of time, such as within a few minutes or seconds. Fourth, the techniques of the present disclosure can provide procurement models used in the energy sector or petroleum industry, including modeling aspects of planned crude oil production for an entire company, and the corresponding services/contracts requirements.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1A is block diagram showing an example of a consolidated demand and price forecasting system for materials and services, according to some implementations of the present disclosure.

FIG. 1B is block diagram showing an example of a conventional, unconsolidated system for materials and services, according to some implementations of the present disclosure.

FIG. 2 is a block diagram showing examples of model inputs, according to some implementations of the present disclosure.

FIGS. 3A-3B are block diagrams that collectively show examples of inputs and outputs for an integrated system providing an integrated process and model for materials and services, according to some implementations of the present disclosure.

FIG. 4 is a flow diagram of an example of a workflow for forecasting the volume and the types of materials and equipment, according to some implementations of the present disclosure.

FIG. 5 is a flow diagram of an example of a workflow for forecasting prices of materials and equipment, according to some implementations of the present disclosure.

FIG. 6 is a flow diagram of an example of a workflow for forecasting volume and types of contract activities, according to some implementations of the present disclosure.

FIG. 7 is a flow diagram of an example of a workflow for forecasting the cost of contracts, according to some implementations of the present disclosure.

FIG. 8 is a block diagram showing examples of other outputs and uses of the model, according to some implementations of the present disclosure.

FIG. 9 is a flowchart of an example of a method for determining estimates used in an integrated materials and services forecasting process and model, according to some implementations of the present disclosure.

FIG. 10 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques used to develop and establish an integrated materials and services forecasting process and model, for example, for an energy company. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure rely of parameters not typically used in conventional systems but useful in a forecasting model. Parameters used in demand forecasting for materials and services for mega projects can include: 1) correlation factors between the number and types of equipment that feed the production of existing oil, gas, refining, chemical storage facilities; and 2) historical costs of all materials and services used in previous mega projects (for example, oil, gas, chemical, refining, storage, pipelines, and civil projects).

Parameters used in demand forecasting for materials and services for upstream and drilling activities can include: 1) correlation factors between historical production with the number and types of wells, and used in maintaining potential requirements, materials, and services; and 2) embedding planned oil, gas, and chemical refined productions in the forecasting model to increase the accuracy of the forecasted data.

Parameters used in cost/price forecasting for materials and services for materials and services can include: 1) forecasted prices for all equipment and all types of contracts procured by the company; and 2) historical prices of all procured materials and services (for all types of contracts).

Parameters used in demand forecasting for materials and services for other operating facilities and non-core activities in the company can include: 1) correlation factors between number and types of equipment that feed the production of existing oil, gas, refining, and chemical storage facilities; and 2 historical costs and uses of all materials and (contracts) services.

The model can be used to provide estimates for prices and quantities of all types of materials and services required by a company. This can help in decision-making related to long-term and short-term procurement and developing procurement strategies. The model can also be used for planning and budgeting (for example, at corporate, organization, sector, and segment levels), and in business development and localization. The model can also be used for commodities and services outsourcing plans, sourcing plans (including strategic agreements and suppliers and contractors sourcing), and financial planning. Use of the model can improve the accuracy and availability of data forecasting related to materials, and future requirements of contracts (for example, based on type, volume, cost, standards, specifications, and new technologies). The model and associated processes can be used as a market intelligence tool for procurement, project management, engineering, planning, and finance organizations. The forecasting model can be integrated with the capacities of suppliers (including manufacturers and contractors).

Benefits of a materials and services model include providing a structured process that integrates all company systems, business activities, company plans, and company organizations/segments. The process and the model can be dynamic to reflect any changes in production, maximum capacities, updates to standards of materials and services, new technologies, and new initiatives impacting materials and contracts activities. Processes using the model can improve clarity, roles, and responsibilities, while enhancing collaboration within the company. Processes using the model can also help in integration with other forecasting and planning process in the company, including cost optimization and optimizing resources within the company. Processes using the model can help in predicting cost of procurement (contracts/materials) for company business activities and organizational divisions, while eliminating redundancies of data storage and strengthening work coordination within company organizations.

Processes using the model can improve profitability by monitoring procuring cost per unit of production (for example, per oil barrel, liquefied gas, chemical product, refined products, and logistics) and help in the standardization and consistency of equipment and services used by the company. Using the model can simplify planning for forecasting subsystems in the company, such as 3-year, 5-year, and 10-year plans. Using the model can govern the documentation (including the approval process) of changes in inputs and outputs of the process and the model, including the introduction of new materials, new services, and new technologies. The process and the model can be fully automated and digitized, allowing all systems related to materials and contracts forecasting to be connected.

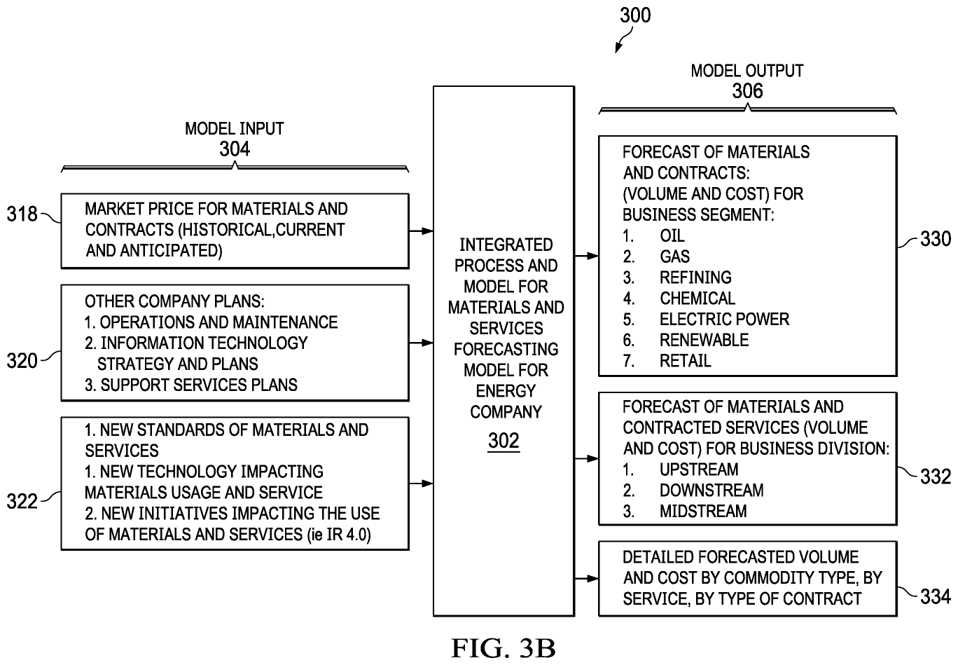

In some implementations, a real-time dashboard or snapshot can provide an up-to-date estimate of the future costs of procurement of the company, such as based on a sum of the estimated cost of materials and the estimated total cost of future contracts and corresponding activities. The term real-time can correspond to events that occur, for example, within a specified period of time, such as within a few minutes or seconds. In some implementations, information displayed to the user can include: 1) a forecast of the cost of materials and contracts for a company budget during a budgeting planning cycle, where the forecasted budget includes a breakdown by the type of company operations (for example, upstream, downstream, and midstream); 2) a monthly or other periodic report that can be generated at any date and time, where the report shows a forecast of the cost of materials and contracts for one segment or function of the company; and 3) a detailed forecast of the cost of commodities or the cost of various contracts in the company, as shown on FIG. 3A.

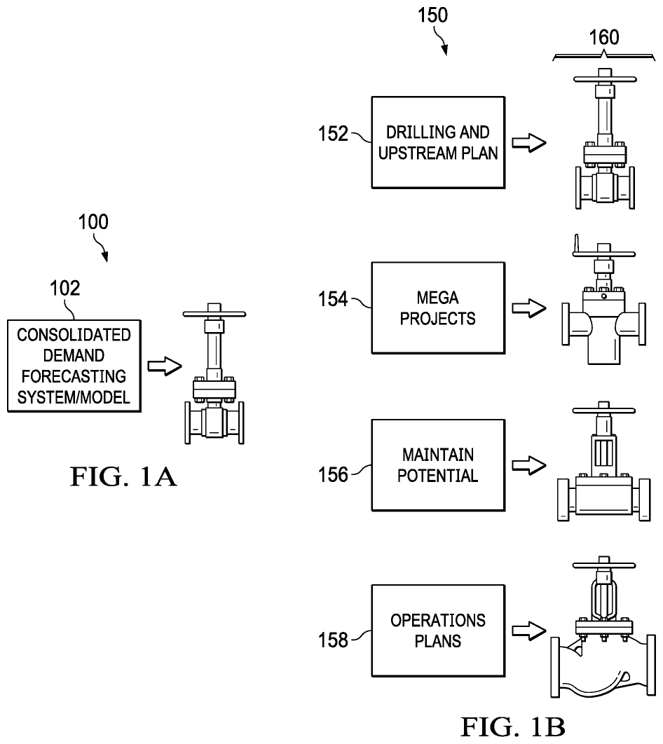

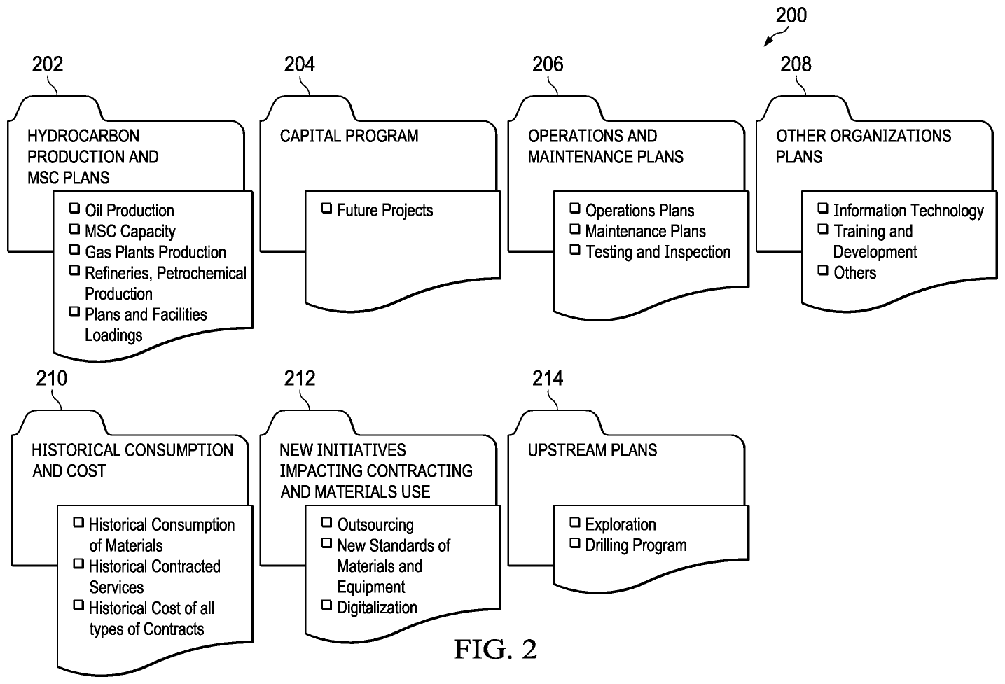

FIG. 1A is block diagram showing an example of a consolidated demand and price forecasting system 100 (or system 100) for materials and services, according to some implementations of the present disclosure. The system 100 includes a consolidated demand forecasting system/model 102 configured to provide a forecasting model configured to oil, gas, refining, and chemical storage facilities. The system 100 can be used for fully-integrated materials and services forecasting demand and price forecasting for materials and services for a valve 104, for example. The system 100 can provide fully digitized demand and price forecasting of direct and non-direct materials and all type of contract activities. The system 100 can provide a collaborative process and model for all organizations, functions, systems integration, planning functions, procurement functions, and market intelligence integration.

FIG. 1B is block diagram showing an example of a conventional, unconsolidated system 150 for materials and services, according to some implementations of the present disclosure. The conventional, unconsolidated system 150 can include components such as a drilling and upstream plan 152, mega projects 154, maintain potential 156, and operations plans 158. However, the typical conventional, unconsolidated are limited in their abilities to coordinate components 152, 154, 156, and 158 into a consolidated system. As such, the components 152, 154, 156, and 158 are depicted in FIG. 1B as producing different versions of valves 160. A side-by-side comparison of the systems 100 and 150 can show that disjointed aspects of separate components of the system 150 can be solved by the consolidated nature of the system 100.

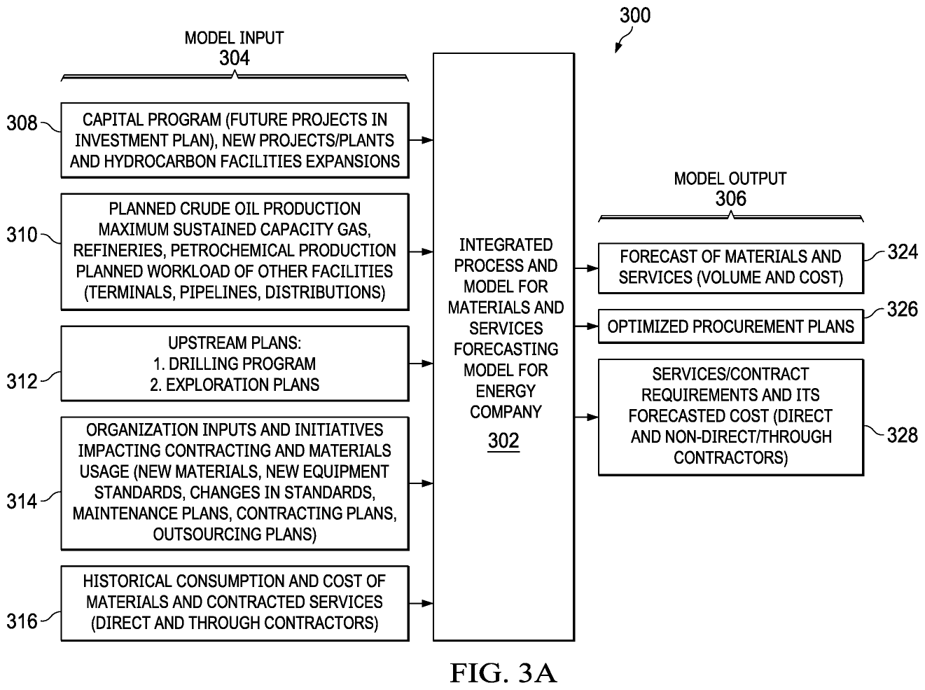

FIG. 2 is a block diagram showing examples of model inputs 200, according to some implementations of the present disclosure. Hydrocarbon production and maximum sustainable capacity (MSC) plans 202 can include oil production, MSC capacity, gas plants production, refineries, petrochemical production, and plants and facilities loadings. Capital program 204 can define future projects, such as related to oil, gas, refining, and chemical storage facilities. Operations and maintenance plans 206 can include operations plans, maintenance plans, and testing and inspection plans. Other organizations' plans 208 can include, for example, information technology (IT) plans, and training and development plans. Historical consumption and cost information 210 can include information about historical consumption of materials, historical contracted services, and historical cost of all types of contracts. New initiatives impacting contracting and materials use 212 can include information and plans about outsourcing, new standards of materials and equipment, and digitization. Upstream plans 214 can include information about exploration and drilling programs.

FIGS. 3A-3B are block diagrams that collectively show examples of inputs and outputs for an integrated system 100 providing an integrated process and model for materials and services, according to some implementations of the present disclosure. The integrated system 100 includes an integrated process and model 302 for materials and services forecasting model for energy company. The integrated process and model 302 uses model inputs 304 and creates model outputs 306.

The model inputs 304 include the following. A capital program 308 includes information about future projects (in investment plans), and information about new projects and plants for hydrocarbon facilities expansion. Planned crude oil production 310 includes information about maximum sustained capacity gas, refineries, petrochemical production, and planned workloads of other facilities, including terminals, pipelines, and distribution. Upstream plans 312 can include information about drilling programs and exploration plans. Organizations inputs and initiatives 314 can include information that impacts contracting and materials usage, including new materials, new equipment standards, changes in standards, maintenance plans, contracting plans, and outsourcing plans. Historical inputs 316 can include historical information about consumption and costs of materials and contracted services, including direct costs and costs incurred through contractors. Market prices for materials and contracts 318 can include historical, current, and anticipated prices. Other company plans 320 can include information about operations and maintenance, IT strategy and plans, and support services plans. New standards of materials and services 322 can include information about new technology impacting materials usage and service, and new initiatives impacting the use of materials and services, for example, associated with the Fourth Industrial Revolution (IR 4.0).

Model outputs 306 can include a forecast 324 of materials and services (including volume and cost) 324, optimized procurement plans 326, services/contracts requirements 328, a volume/cost forecast 330 of materials and contracts, a volume/cost forecast 332 of materials and contracted services, and detailed forecasted volumes and costs 334. The services/contracts requirements 328 can include forecasted costs, including direct costs and non-direct costs incurred through contractors. The volume/cost forecast 330 of materials and contracts can apply to business segments, including oil, gas, refining, chemical, electric power, renewables, and retail. The volume/cost forecast 332 of materials and contracted services can apply to business divisions, including upstream, downstream, midstream businesses. The detailed forecasted volumes and costs 334 can be provided by commodity type, for example, summarized by service and by type of contract.

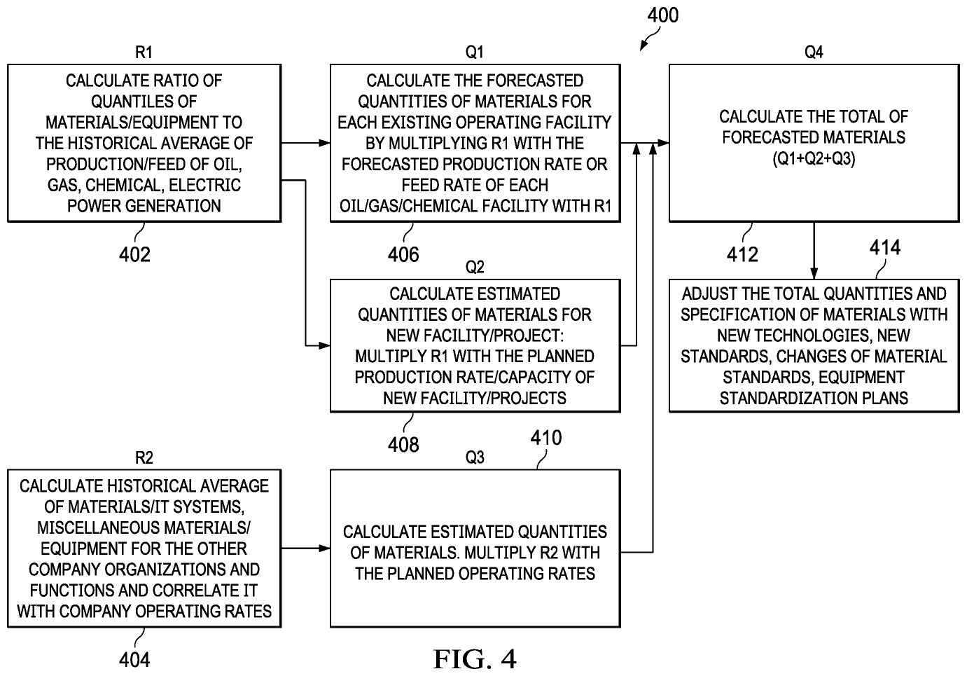

FIG. 4 is a flow diagram of an example of a workflow 400 for forecasting the volume and the types of materials and equipment, according to some implementations of the present disclosure. The workflow 400 can be used, for example, by an energy company.

At 402, a ratio R1 of quantiles of materials and equipment are calculated based on a historical average of production/feed of oil, gas, chemical, and electric power generation. At 404, historical averages R2 of materials/IT systems are calculated, including for miscellaneous materials equipment for other company organizations and functions. The historical averages R2 are correlated with company operating rates.

At 406, forecasted quantities Q1 of materials for each existing operating facility by are calculated by multiplying R1 with the forecasted production rate or feed rate of each oil/gas/chemical facility. At 408, estimated quantities Q2 of materials are calculated for new facilities and projects. R1 is multiplied with the planned production rates and capacities of new facilities and projects. At 410, estimated quantities Q3 of materials are calculated. Planned operating rates are multiplied by R2.

At 412, a total Q4 of forecasted materials is calculated, for example, as Q1+Q2+Q3. At 414, adjustments are made to total quantities and specifications of materials with new technologies, new standards, changes of materials standards, and equipment standardization plans.

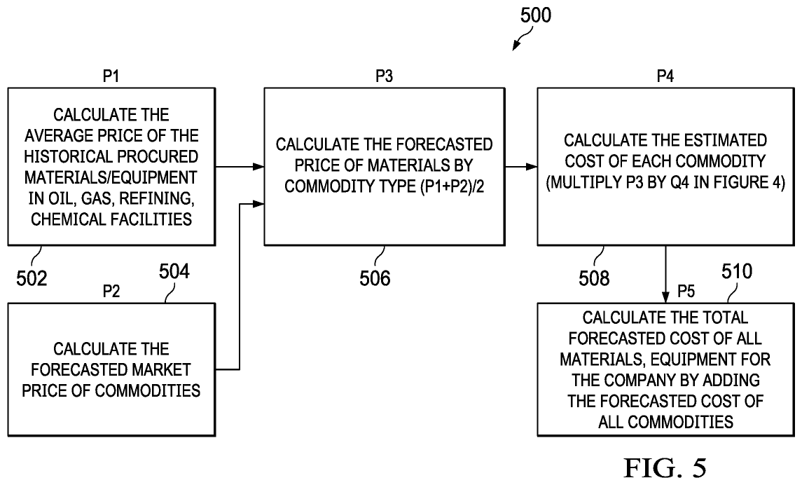

FIG. 5 is a flow diagram of an example of a workflow 500 for forecasting prices of materials and equipment, according to some implementations of the present disclosure. The workflow 500 can be used, for example, by an energy company.

At 502, the average price P1 is calculated based on historical procured materials and equipment for oil, gas, refining, and chemical facilities. At 504, a forecasted market price P2 of commodities is calculated.

At 506, a forecasted price P3 of materials is calculated, for example, by commodity type and using (P1+P2)/2. At 508, an estimated cost P4 of each commodity is calculated, for example, by multiplying P3 by Q4. At 510, a total forecasted cost P5 of all materials, equipment for the company is calculated, for example, by adding the forecasted cost of all commodities.

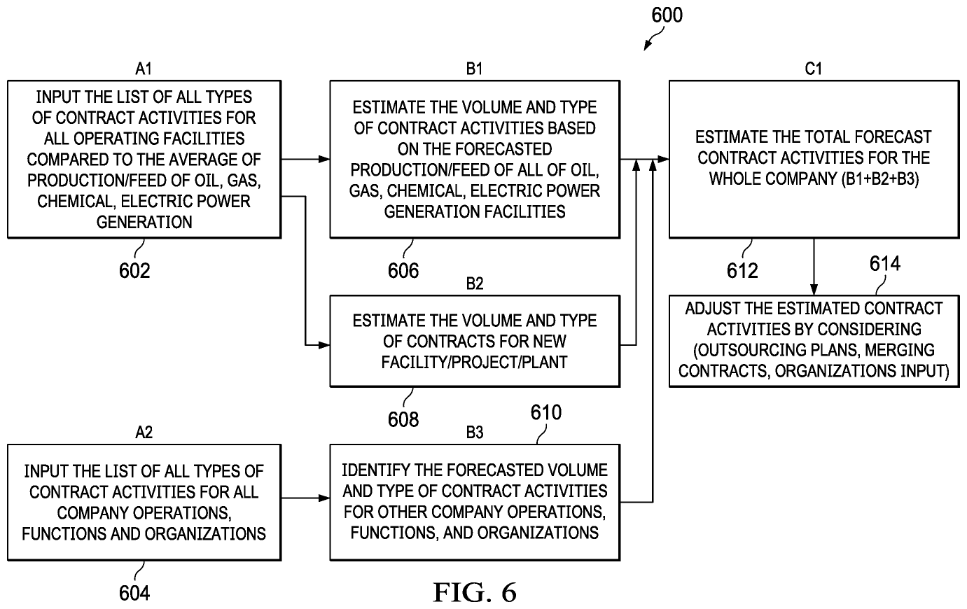

FIG. 6 is a flow diagram of an example of a workflow 600 for forecasting volume and types of contract activities, according to some implementations of the present disclosure. The workflow 600 can be used, for example, by an energy company.

At 602, a list A1 is input that includes all types of contacts activities for all operating facilities. The list is compared to the historical average of production/feed of oil, gas, chemical, and electric power generation. At 604, a list A2 is input that includes all type of contacts activities for all company operations, functions, and organizations.

At 606, an estimate B1 is made for the volume and type of contacts activities based on the forecasted production/feed of all of oil, gas, chemical, electric power generation facilities. At 608, an estimate B2 is made for the volume and type of contracts for new facilities/projects/plants. At 610, a forecasted volume B3 and type is identified for contracts activities for other company operations, functions, and organizations.

At 612, a total forecast Cl is estimated for contracts activities for the whole company, for example, using B1+B2+B3. At 614, the estimated contracts activities are adjusted by considering outsourcing plans, merging contracts, and organizations input.

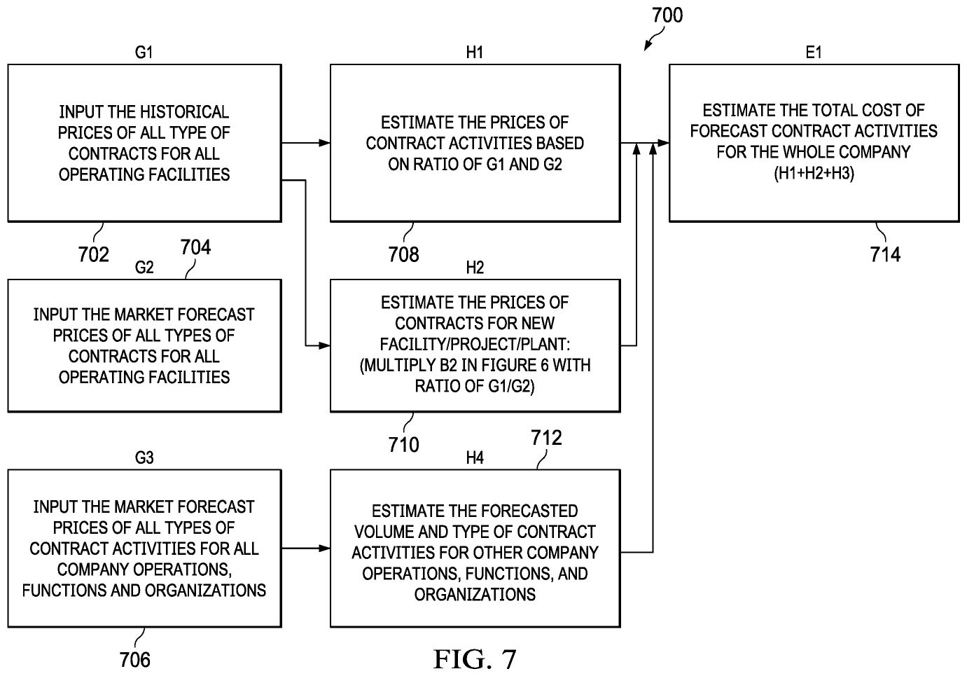

FIG. 7 is a flow diagram of an example of a workflow 700 for forecasting the cost of contracts, according to some implementations of the present disclosure. The workflow 700 can be used, for example, by an energy company.

At 702, the historical prices G1 of all types of contacts are input for all operating facilities. At 704, market forecast prices G2 of all type of contacts are input for all operating facilities. At 706, market forecast prices G3 of all type of contacts activities are input for all company operations, functions, and organizations.

At 708, prices H1 of contracts activities are estimated based on ratio of G1 and G2. At 710, prices H2 of contracts for new facilities/projects/plants are estimated, for example, by multiplying B2 with the ratio of G1/G2. At 712, forecasted volume H4 and type of contracts activities are estimated for other company operations, functions, and organizations.

At 714, a total cost E1 of forecast contracts activities is estimated for the whole company, for example, using H1+H2+H3. The future cost of procurement of the company can be given by a sum of P4 (estimated cost of materials)+E1 (estimated total cost of future contracts activities).

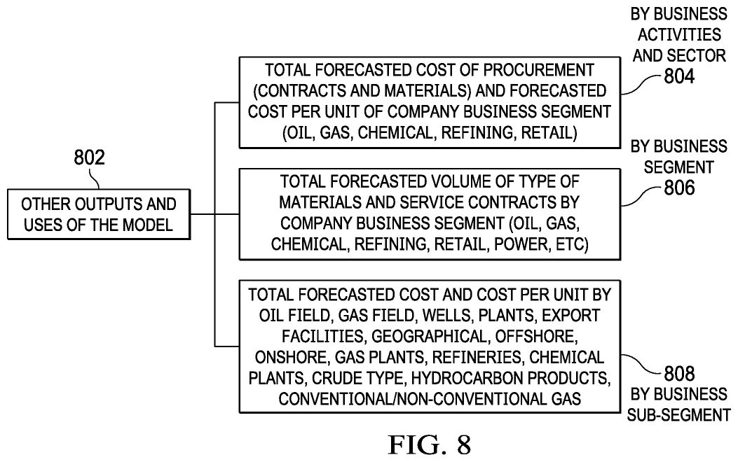

FIG. 8 is a block diagram showing examples of other outputs and uses 802 of the model, according to some implementations of the present disclosure. For example, other uses can include forecasted costs of procurement per unit of production, in addition to the following.

Uses 804 of the model, applicable to business activities and sectors, for example, can include the total forecasted cost of procurement (including contracts and materials) and forecasted cost-per-unit of company business segments (for example, oil, gas, chemical, refining, and retail). Uses 806, applicable to business segments, for example, can include the total forecasted volume of types of materials and service contracts by company business segment (for example, oil, gas, chemical, refining, retail, and power). Uses 808, applicable to business sub-segments, for example, can include the total forecasted cost and cost-per-unit by different categories. The categories can include, for example, oil fields, gas fields, wells, plants, export facilities, geographical area, offshore, onshore, gas plants, refineries, chemical plants, crude type, hydrocarbon products, and conventional and non-conventional gas.

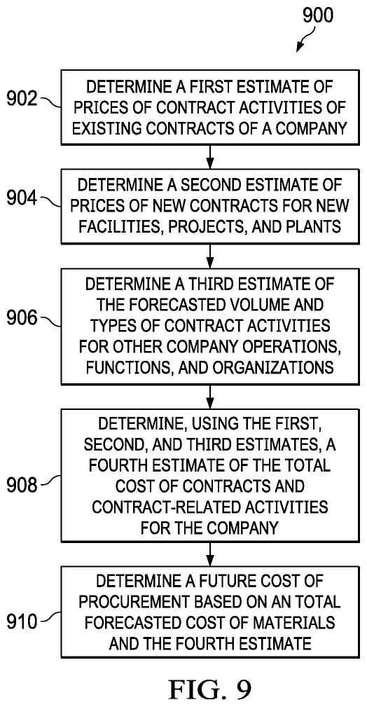

FIG. 9 is a flowchart of an example of a method 900 for determining estimates used in an integrated materials and services forecasting process and model, according to some implementations of the present disclosure. For clarity of presentation, the description that follows generally describes method 900 in the context of the other figures in this description. However, it will be understood that method 900 can be performed, for example, by any suitable system, environment, software, and hardware, or a combination of systems, environments, software, and hardware, as appropriate. In some implementations, various steps of method 900 can be run in parallel, in combination, in loops, or in any order.

At 902, a first estimate of prices of contract activities of existing contracts of a company is determined. For example, determining the first estimate can be based on a ratio of: i) historical prices of all types of contacts for all operating facilities, and ii) market forecast prices of all type of contacts for all operating facilities. From 902, method 900 proceeds to 904.

At 904, a second estimate of prices of new contracts for new facilities, projects, and plants is determined. As an example, determining the second estimate can be based on a product of the volume and type of contracts for new facilities, projects, and plants and a ratio of: i) historical prices of all types of contacts for all operating facilities; and ii) market forecast prices of all type of contacts for all operating facilities. From 904, method 900 proceeds to 906.

At 906, a third estimate of the forecasted volume and types of contracts activities for other company operations, functions, and organizations is determined. From 906, method 900 proceeds to 908.

At 908, a fourth estimate of the total cost of contracts and contract-related activities for the company is determined using the first, second, and third estimates. From 908, method 900 proceeds to 910.

At 910, a future cost of procurement is determined based on a total forecasted cost of materials and the fourth estimate. For example, the future cost of procurement can be calculated as described with reference to step 714 of FIG. 7. After 910, method 900 can stop.

In some implementations, method 900 further includes providing a real-time dashboard or snapshot that includes an up-to-date estimate of the future costs of procurement of the company, including materials and services. For example, any or all of the estimates that are described in the present disclosure can be presented in a graphical user interface. In some implementations, drill-down capabilities can be provided to display information regarding the calculation or estimation of a particular value.

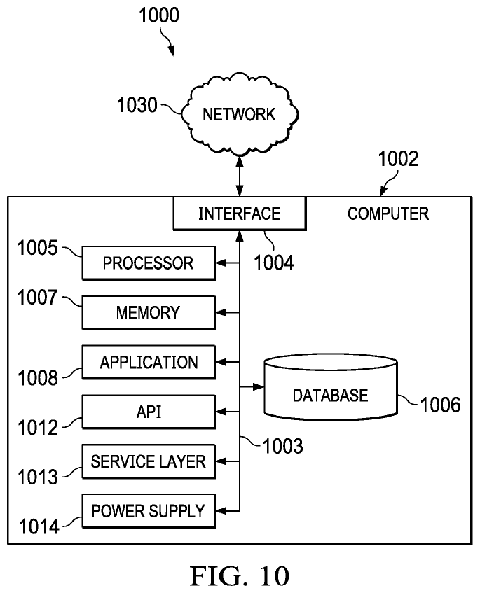

FIG. 10 is a block diagram of an example computer system 1000 used to provide computational functionalities associated with described algorithms, methods, functions, processes, flows, and procedures described in the present disclosure, according to some implementations of the present disclosure. The illustrated computer 1002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1002 can include input devices such as keypads, keyboards, and touch screens that can accept user information. Also, the computer 1002 can include output devices that can convey information associated with the operation of the computer 1002. The information can include digital data, visual data, audio information, or a combination of information. The information can be presented in a graphical user interface (UI) (or GUI).

The computer 1002 can serve in a role as a client, a network component, a server, a database, a persistency, or components of a computer system for performing the subject matter described in the present disclosure. The illustrated computer 1002 is communicably coupled with a network 1030. In some implementations, one or more components of the computer 1002 can be configured to operate within different environments, including cloud-computing-based environments, local environments, global environments, and combinations of environments.

At a top level, the computer 1002 is an electronic computing device operable to receive, transmit, process, store, and manage data and information associated with the described subject matter. According to some implementations, the computer 1002 can also include, or be communicably coupled with, an application server, an email server, a web server, a caching server, a streaming data server, or a combination of servers.

The computer 1002 can receive requests over network 1030 from a client application (for example, executing on another computer 1002). The computer 1002 can respond to the received requests by processing the received requests using software applications. Requests can also be sent to the computer 1002 from internal users (for example, from a command console), external (or third) parties, automated applications, entities, individuals, systems, and computers.

Each of the components of the computer 1002 can communicate using a system bus 1003. In some implementations, any or all of the components of the computer 1002, including hardware or software components, can interface with each other or the interface 1004 (or a combination of both) over the system bus 1003. Interfaces can use an application programming interface (API) 1012, a service layer 1013, or a combination of the API 1012 and service layer 1013. The API 1012 can include specifications for routines, data structures, and object classes. The API 1012 can be either computer-language independent or dependent. The API 1012 can refer to a complete interface, a single function, or a set of APIs.

The service layer 1013 can provide software services to the computer 1002 and other components (whether illustrated or not) that are communicably coupled to the computer 1002. The functionality of the computer 1002 can be accessible for all service consumers using this service layer. Software services, such as those provided by the service layer 1013, can provide reusable, defined functionalities through a defined interface. For example, the interface can be software written in JAVA, C++, or a language providing data in extensible markup language (XML) format. While illustrated as an integrated component of the computer 1002, in alternative implementations, the API 1012 or the service layer 1013 can be stand-alone components in relation to other components of the computer 1002 and other components communicably coupled to the computer 1002. Moreover, any or all parts of the API 1012 or the service layer 1013 can be implemented as child or sub-modules of another software module, enterprise application, or hardware module without departing from the scope of the present disclosure.

The computer 1002 includes an interface 1004. Although illustrated as a single interface 1004 in FIG. 10, two or more interfaces 1004 can be used according to particular needs, desires, or particular implementations of the computer 1002 and the described functionality. The interface 1004 can be used by the computer 1002 for communicating with other systems that are connected to the network 1030 (whether illustrated or not) in a distributed environment. Generally, the interface 1004 can include, or be implemented using, logic encoded in software or hardware (or a combination of software and hardware) operable to communicate with the network 1030. More specifically, the interface 1004 can include software supporting one or more communication protocols associated with communications. As such, the network 1030 or the interface's hardware can be operable to communicate physical signals within and outside of the illustrated computer 1002.

The computer 1002 includes a processor 1005. Although illustrated as a single processor 1005 in FIG. 10, two or more processors 1005 can be used according to particular needs, desires, or particular implementations of the computer 1002 and the described functionality. Generally, the processor 1005 can execute instructions and can manipulate data to perform the operations of the computer 1002, including operations using algorithms, methods, functions, processes, flows, and procedures as described in the present disclosure.

The computer 1002 also includes a database 1006 that can hold data for the computer 1002 and other components connected to the network 1030 (whether illustrated or not). For example, database 1006 can be an in-memory, conventional, or a database storing data consistent with the present disclosure. In some implementations, database 1006 can be a combination of two or more different database types (for example, hybrid in-memory and conventional databases) according to particular needs, desires, or particular implementations of the computer 1002 and the described functionality. Although illustrated as a single database 1006 in FIG. 10, two or more databases (of the same, different, or combination of types) can be used according to particular needs, desires, or particular implementations of the computer 1002 and the described functionality. While database 1006 is illustrated as an internal component of the computer 1002, in alternative implementations, database 1006 can be external to the computer 1002.

The computer 1002 also includes a memory 1007 that can hold data for the computer 1002 or a combination of components connected to the network 1030 (whether illustrated or not). Memory 1007 can store any data consistent with the present disclosure. In some implementations, memory 1007 can be a combination of two or more different types of memory (for example, a combination of semiconductor and magnetic storage) according to particular needs, desires, or particular implementations of the computer 1002 and the described functionality. Although illustrated as a single memory 1007 in FIG. 10, two or more memories 1007 (of the same, different, or combination of types) can be used according to particular needs, desires, or particular implementations of the computer 1002 and the described functionality. While memory 1007 is illustrated as an internal component of the computer 1002, in alternative implementations, memory 1007 can be external to the computer 1002.

The application 1008 can be an algorithmic software engine providing functionality according to particular needs, desires, or particular implementations of the computer 1002 and the described functionality. For example, application 1008 can serve as one or more components, modules, or applications. Further, although illustrated as a single application 1008, the application 1008 can be implemented as multiple applications 1008 on the computer 1002. In addition, although illustrated as internal to the computer 1002, in alternative implementations, the application 1008 can be external to the computer 1002.

The computer 1002 can also include a power supply 1014. The power supply 1014 can include a rechargeable or non-rechargeable battery that can be configured to be either user- or non-user-replaceable. In some implementations, the power supply 1014 can include power-conversion and management circuits, including recharging, standby, and power management functionalities. In some implementations, the power-supply 1014 can include a power plug to allow the computer 1002 to be plugged into a wall socket or a power source to, for example, power the computer 1002 or recharge a rechargeable battery.

There can be any number of computers 1002 associated with, or external to, a computer system containing computer 1002, with each computer 1002 communicating over network 1030. Further, the terms “client,” “user,” and other appropriate terminology can be used interchangeably, as appropriate, without departing from the scope of the present disclosure. Moreover, the present disclosure contemplates that many users can use one computer 1002 and one user can use multiple computers 1002.

Described implementations of the subject matter can include one or more features, alone or in combination.

For example, in a first implementation, a computer-implemented method includes the following. A first estimate of prices of contract activities of existing contracts of a company is determined. A second estimate of prices of new contracts for new facilities, projects, and plants is determined. A third estimate of the forecasted volume and types of contracts activities for other company operations, functions, and organizations is determined. A fourth estimate of the total cost of contracts and contract-related activities for the company is determined using the first, second, and third estimates. A future cost of procurement is determined based on a total forecasted cost of materials and the fourth estimate.

The foregoing and other described implementations can each, optionally, include one or more of the following features:

A first feature, combinable with any of the following features, where determining the first estimate is based on a ratio of: i) historical prices of all types of contacts for all operating facilities, and ii) market forecast prices of all type of contacts for all operating facilities.

A second feature, combinable with any of the previous or following features, where determining the second estimate is based on a product of a volume and type of contracts for new facilities, projects, and plants and a ratio of: i) historical prices of all types of contacts for all operating facilities; and ii) market forecast prices of all type of contacts for all operating facilities.

A third feature, combinable with any of the previous or following features, where the company is an oil facility, a gas facility, a refining facility, and chemical storage facility.

A fourth feature, combinable with any of the previous or following features, the method further including determining parameters used in demand forecasting for materials and services for upstream and drilling activities, including: 1) correlation factors between historical production with a number and types of wells, and used in maintaining potential requirements, materials, and services; and 2) embedding planned oil, gas, and chemical refined productions in a forecasting model to improve the accuracy of forecasted data.

A fifth feature, combinable with any of the previous or following features, the method further including determining parameters used in cost/price forecasting for materials and services for materials and services, including: 1) forecasted prices for all equipment and all types of contracts procured by the company; and 2) historical prices of all procured materials and services for all types of contracts.

A sixth feature, combinable with any of the previous or following features, the method further including providing a real-time dashboard or snapshot that includes an up-to-date estimate of the future costs of procurement of the company, including materials and services.

In a second implementation, a computer-implemented system includes one or more processors and a non-transitory computer-readable storage medium coupled to the one or more processors and storing programming instructions for execution by the one or more processors. The programming instructions instruct the one or more processors to perform operations including the following. A first estimate of prices of contract activities of existing contracts of a company is determined. A second estimate of prices of new contracts for new facilities, projects, and plants is determined. A third estimate of the forecasted volume and types of contracts activities for other company operations, functions, and organizations is determined. A fourth estimate of the total cost of contracts and contract-related activities for the company is determined using the first, second, and third estimates. A future cost of procurement is determined based on a total forecasted cost of materials and the fourth estimate.

The foregoing and other described implementations can each, optionally, include one or more of the following features:

A first feature, combinable with any of the following features, where determining the first estimate is based on a ratio of: i) historical prices of all types of contacts for all operating facilities, and ii) market forecast prices of all type of contacts for all operating facilities.

A second feature, combinable with any of the previous or following features, where determining the second estimate is based on a product of a volume and type of contracts for new facilities, projects, and plants and a ratio of: i) historical prices of all types of contacts for all operating facilities; and ii) market forecast prices of all type of contacts for all operating facilities.

A third feature, combinable with any of the previous or following features, where the company is an oil facility, a gas facility, a refining facility, and chemical storage facility.

A fourth feature, combinable with any of the previous or following features, the operations further including determining parameters used in demand forecasting for materials and services for upstream and drilling activities, including: 1) correlation factors between historical production with a number and types of wells, and used in maintaining potential requirements, materials, and services; and 2) embedding planned oil, gas, and chemical refined productions in a forecasting model to improve the accuracy of forecasted data.

A fifth feature, combinable with any of the previous or following features, the operations further including determining parameters used in cost/price forecasting for materials and services for materials and services, including: 1) forecasted prices for all equipment and all types of contracts procured by the company; and 2) historical prices of all procured materials and services for all types of contracts.

A sixth feature, combinable with any of the previous or following features, the operations further including providing a real-time dashboard or snapshot that includes an up-to-date estimate of the future costs of procurement of the company, including materials and services.

In a third implementation, a non-transitory, computer-readable medium stores one or more instructions executable by a computer system to perform operations including the following. A first estimate of prices of contract activities of existing contracts of a company is determined. A second estimate of prices of new contracts for new facilities, projects, and plants is determined. A third estimate of the forecasted volume and types of contracts activities for other company operations, functions, and organizations is determined. A fourth estimate of the total cost of contracts and contract-related activities for the company is determined using the first, second, and third estimates. A future cost of procurement is determined based on a total forecasted cost of materials and the fourth estimate.

The foregoing and other described implementations can each, optionally, include one or more of the following features:

A first feature, combinable with any of the following features, where determining the first estimate is based on a ratio of: i) historical prices of all types of contacts for all operating facilities, and ii) market forecast prices of all type of contacts for all operating facilities.

A second feature, combinable with any of the previous or following features, where determining the second estimate is based on a product of a volume and type of contracts for new facilities, projects, and plants and a ratio of: i) historical prices of all types of contacts for all operating facilities; and ii) market forecast prices of all type of contacts for all operating facilities.

A third feature, combinable with any of the previous or following features, where the company is an oil facility, a gas facility, a refining facility, and chemical storage facility.

A fourth feature, combinable with any of the previous or following features, the operations further including determining parameters used in demand forecasting for materials and services for upstream and drilling activities, including: 1) correlation factors between historical production with a number and types of wells, and used in maintaining potential requirements, materials, and services; and 2) embedding planned oil, gas, and chemical refined productions in a forecasting model to improve the accuracy of forecasted data.

A fifth feature, combinable with any of the previous or following features, the operations further including determining parameters used in cost/price forecasting for materials and services for materials and services, including: 1) forecasted prices for all equipment and all types of contracts procured by the company; and 2) historical prices of all procured materials and services for all types of contracts.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
determining a first estimate of prices of contract activities of existing contracts of a company;
determining a second estimate of prices of new contracts for new facilities, projects, and plants;
determining a third estimate of a forecasted volume and types of contracts activities for other company operations, functions, and organizations;
determining, using the first, second, and third estimates, a fourth estimate of a total cost of contracts and contract-related activities for the company; and
determining a future cost of procurement based on an total forecasted cost of materials and the fourth estimate.

2. The computer-implemented method of claim 1, wherein determining the first estimate is based on a ratio of: i) historical prices of all types of contacts for all operating facilities, and ii) market forecast prices of all type of contacts for all operating facilities.

3. The computer-implemented method of claim 1, wherein determining the second estimate is based on a product of a volume and type of contracts for new facilities, projects, and plants and a ratio of: i) historical prices of all types of contacts for all operating facilities; and ii) market forecast prices of all type of contacts for all operating facilities.

4. The computer-implemented method of claim 1, wherein the company is selected from a group comprising an oil facility, a gas facility, a refining facility, and chemical storage facility.

5. The computer-implemented method of claim 1, further comprising determining parameters used in demand forecasting for materials and services for upstream and drilling activities, including: 1) correlation factors between historical production with a number and types of wells, and used in maintaining potential requirements, materials, and services; and 2) embedding planned oil, gas, and chemical refined productions in a forecasting model to improve the accuracy of forecasted data.

6. The computer-implemented method of claim 1, further comprising determining parameters used in cost/price forecasting for materials and services for materials and services, including: 1) forecasted prices for all equipment and all types of contracts procured by the company; and 2) historical prices of all procured materials and services for all types of contracts.

7. The computer-implemented method of claim 1, further comprising providing a real-time dashboard or snapshot that includes an up-to-date estimate of the future costs of procurement of the company, including materials and services.

8. A computer-implemented system, comprising:
an integrated materials and services forecasting model;
data used by the integrated materials and services forecasting model, the data including historical prices of contracts and materials, current and new contracts, current and proposed production rates, and forecasted prices of commodities;
one or more user interfaces for inputting the data and for displaying information resulting from execution of the integrated materials and services forecasting model;
one or more processors; and
a non-transitory computer-readable storage medium coupled to the one or more processors and storing programming instructions for execution by the one or more processors, the programming instructions instructing the one or more processors to perform operations comprising:
determining a first estimate of prices of contract activities of existing contracts of a company;
determining a second estimate of prices of new contracts for new facilities, projects, and plants;
determining a third estimate of a forecasted volume and types of contracts activities for other company operations, functions, and organizations;
determining, using the first, second, and third estimates, a fourth estimate of a total cost of contracts and contract-related activities for the company; and
determining a future cost of procurement based on an total forecasted cost of materials and the fourth estimate.

9. The computer-implemented system of claim 8, wherein determining the first estimate is based on a ratio of: i) historical prices of all types of contacts for all operating facilities, and ii) market forecast prices of all type of contacts for all operating facilities.

10. The computer-implemented system of claim 8, wherein determining the second estimate is based on a product of a volume and type of contracts for new facilities, projects, and plants and a ratio of: i) historical prices of all types of contacts for all operating facilities; and ii) market forecast prices of all type of contacts for all operating facilities.

11. The computer-implemented system of claim 8, wherein the company is selected from a group comprising an oil facility, a gas facility, a refining facility, and chemical storage facility.

12. The computer-implemented system of claim 8, further comprising determining parameters used in demand forecasting for materials and services for upstream and drilling activities, including: 1) correlation factors between historical production with a number and types of wells, and used in maintaining potential requirements, materials, and services; and 2) embedding planned oil, gas, and chemical refined productions in a forecasting model to improve the accuracy of forecasted data.

13. The computer-implemented system of claim 8, further comprising determining parameters used in cost/price forecasting for materials and services for materials and services, including: 1) forecasted prices for all equipment and all types of contracts procured by the company; and 2) historical prices of all procured materials and services for all types of contracts.

14. The computer-implemented system of claim 8, further comprising providing a real-time dashboard or snapshot that includes an up-to-date estimate of the future costs of procurement of the company, including materials and services.

15. A non-transitory, computer-readable medium storing one or more instructions executable by a computer system to perform operations comprising:
determining a first estimate of prices of contract activities of existing contracts of a company;
determining a second estimate of prices of new contracts for new facilities, projects, and plants;
determining a third estimate of a forecasted volume and types of contracts activities for other company operations, functions, and organizations;
determining, using the first, second, and third estimates, a fourth estimate of a total cost of contracts and contract-related activities for the company; and
determining a future cost of procurement based on an total forecasted cost of materials and the fourth estimate.

16. The non-transitory, computer-readable medium of claim 15, wherein determining the first estimate is based on a ratio of: i) historical prices of all types of contacts for all operating facilities, and ii) market forecast prices of all type of contacts for all operating facilities.

17. The non-transitory, computer-readable medium of claim 15, wherein determining the second estimate is based on a product of a volume and type of contracts for new facilities, projects, and plants and a ratio of: i) historical prices of all types of contacts for all operating facilities; and ii) market forecast prices of all type of contacts for all operating facilities.

18. The non-transitory, computer-readable medium of claim 15, wherein the company is selected from a group comprising an oil facility, a gas facility, a refining facility, and chemical storage facility.

19. The non-transitory, computer-readable medium of claim 15, further comprising determining parameters used in demand forecasting for materials and services for upstream and drilling activities, including: 1) correlation factors between historical production with a number and types of wells, and used in maintaining potential requirements, materials, and services; and 2) embedding planned oil, gas, and chemical refined productions in a forecasting model to improve the accuracy of forecasted data.

20. The non-transitory, computer-readable medium of claim 15, further comprising determining parameters used in cost/price forecasting for materials and services for materials and services, including: 1) forecasted prices for all equipment and all types of contracts procured by the company; and 2) historical prices of all procured materials and services for all types of contracts.
